(19) United States
(12) Patent Application Publication
(10) Pub. No.: US 2024/0193435 A1
(43) Pub. Date: Jun. 13, 2024

(54) FEDERATED TRAINING FOR A NEURAL NETWORK WITH REDUCED COMMUNICATION REQUIREMENT

(71) Applicant: Robert Bosch GmbH, Stuttgart (DE)

(72) Inventor: Andres Mauricio Munoz Delgado, SCHOENAICH (DE)

(21) Appl. No.: 18/530,552

(22) Filed: Dec. 6, 2023

(30) Foreign Application Priority Data
Dec. 12, 2022 (DE) 10 2022 213 485.0

(51) Int. Cl. G06N 3/098

(52) U.S. Cl. CPC G06N 3/098

(57) ABSTRACT

A method for generating a training contribution for a neural network on a client node for a federated training of the neural network. In the method, a complete set of parameters characterizing the behavior of the neural network is received; the parameterized neural network is supplied with training examples from a predefined set so that the neural network in each case delivers outputs, wherein the training examples are labeled with target outputs; deviations of the outputs from the respective target outputs are evaluated with a predefined cost function; the parameters of the neural network are optimized with the aim of improving the evaluation by the cost function; a set of particularly relevant parameters is selected based on a predefined criterion; for the selected parameters, proposed changes are ascertained as the sought training contribution based on the result of the optimization; the proposed changes are transmitted to a server node.

### FIELD

The present invention relates to the federated training of neural networks, in which a large number of client nodes C1, . . . , CN work together in a manner coordinated by a server node Q.

### BACKGROUND INFORMATION

The training of neural networks, such as those used for the classification and/or semantic segmentation of images, requires a large number of training examples with sufficient variability. The effort required to store these training examples and for the actual training may be too great for a single entity. For legal reasons, it is also not always possible to merge all training examples in one entity that carries out the training. For example, an image classifier for monitoring the surroundings of a vehicle driving in at least partially automated fashion requires, as training examples, images that may contain license plates, faces, and other personal data. If this image classifier is to be trained in such a way that it works equally well not only in North America and Europe but also in other regions of the world, the merging of all training examples for carrying out the training may fail due to data protection laws, such as the European General Data Protection Regulation (GDPR).

One solution is federated learning, in which a large number of client nodes C1, . . . , CN trains the neural network on a local data set of training examples in each case, and the respective work results are collected in a server node Q. In this case, the parameters W that characterize the behavior of the neural network must be repeatedly communicated between the server node Q and the client nodes C1, . . . , CN.

### SUMMARY

The present invention provides a method for generating a training contribution for a neural network on a client node C1, . . . , CN for a federated training of the neural network. As will be explained later, a central server node Q can use these training contributions to ascertain the values that are optimal in terms of a predefined task, for parameters W that characterize the behavior of the neural network.

According to an example embodiment of the present invention, the method begins with the client node C1, . . . , CN receiving a complete set of parameters W that characterize the behavior of the neural network, from a server node Q. These parameters W may, for example, have been initialized randomly by the server node Q.

However, they may also, for example, be the result of a training that has already been carried out and is to be further optimized and/or refined.

Training examples x from a predefined set D are provided to the neural network parameterized with the parameters W. The neural network then delivers outputs y. In particular, each client node C1, . . . , CN can have its own set D1, . . . , DN of training examples x. The training examples x are each labeled with target outputs y* which the neural network ideally delivers when it processes the respective training example x.

According to an example embodiment of the present invention, deviations of the outputs y from the respective target outputs y* are evaluated with a predefined cost function L. The parameters W of the neural network are optimized with the aim of ensuring that, during further processing of training examples x, the evaluation by the cost function L is improved. The optimization can be carried out using any suitable optimization method, such as stochastic gradient descent. The result is an optimized set of parameters W*.

A set of particularly relevant parameters W^{#} is now selected on the basis of a predefined criterion. For these selected parameters W^{#}, proposed changes ΔW^{#} are ascertained as the sought training contribution on the basis of the result W* of the optimization. The proposed changes ΔW^{#} are transmitted to a server node Q. In particular, this may, for example, be the same server node Q from which the original set of parameters W was also received. However, it may also be another server node Q that is involved in the federated training of the same neural network 1. For example, a plurality of such server nodes Q can operate in combination.

It has been recognized that especially in federated learning with a large number of client nodes C1, . . . , CN, each client node C1, . . . , CN provides, only for a few relevant parameters W^{#}, proposed changes ΔW^{#} that have retained validity in the light of the contributions of all other client nodes C1, . . . , CN and have an effect on the new parameters W ultimately formed by the server node Q. Although each client node C1, . . . , CN can make proposed changes for all parameters W, a very small proposed change in terms of magnitude from a client node C1, . . . , CN for an individual parameter Wᵢ is, for example, completely lost if another client node C1, . . . , CN makes a much larger proposed change for the same individual parameter WV. Even small proposed changes from many client nodes C1, . . . , CN in relation to one and the same individual parameter WV can cancel each other out completely or partially. In this situation, the generation and transmission of proposed changes that are not reflected in the final result anyway can be omitted, and a large amount of transmission bandwidth can be saved in this way. A complete set of parameters W can be several GB in size, which requires a correspondingly powerful network connection. If a client node C1, . . . , CN is connected via mobile radio, for example, the monthly data volume is often subject to a limit. Data traffic between geographic regions or between the cloud and the public Internet is also often taken into account in the case of implementation in a cloud.

The relevant parameters W^{#} can, for example, be selected on the basis of any quantitative relevance measure from the set of all available parameters W. This relevance measure can in particular be motivated by the respectively intended application of the neural network, for example.

However, it is not necessary for such a specific relevance measure to exist for the respective application. Instead, for example, a relevance measure motivated purely by information theory can also be used without regard to a specific application. Therefore, in a particularly advantageous embodiment, the predefined criterion for the relevance of the parameters W measures a functional dependence of the probability p(W|D) that, for given training examples D, the set of parameters W is correct overall, on individual parameters Wᵢ. This is motivated by the information-theoretical goal of finding, for a given set D of training examples x, the complete set of parameters W for which p(W|D) becomes maximum. The set of parameters W that is most probable in light of the set D of training examples x is then regarded as the optimal set of parameters W.

Directly calculating the probability p(W|D) is very complicated because all possible combinations of parameters would have to be taken into account for this purpose. If, however, only the first order of a Laplace expansion of this probability p(W|D) is taken into account, it can be approximated as

$${{p ( W \vert D ) ∼ N ( {W}^{* *} , ( - \frac{{\partial }^{2} ( log ( p ( W \vert D ) ) )}{{\partial }^{2} W} \vert}_{{W}^{* *}} )}^{- 1} ) = N ( {W}^{* *} , {F}^{- 1} ) .$$

Here, W** is the optimal set of parameters. F is the Fisher information matrix. This is a square matrix with as many rows and columns as there are parameters W. If the parameters W are close to the optimum W**, the matrix F approximates the second derivative of the cost function L and therefore describes the curvature of the “surface” or “landscape” defined by the cost function L. This can be interpreted as the sensitivity of the cost function L to changes in individual parameters Wᵢ: If an individual parameter Wᵢ is changed in a region with large curvature, this has a greater effect on the value of the cost function L than in a region with a smaller curvature.

Thus, in a particularly advantageous embodiment of the present invention, an approximation for the probability p(W|D) is established, which comprises derivatives of the probability Substitute Specification p(W|D) and/or of its logarithm log (p(W|D)) according to individual parameters Wᵢ.

The Fisher information matrix F specifically indicates, on its diagonal, the information content (also called Fisher information) of each individual parameter Wᵢ under the assumption that the individual parameters Wᵢ do not interact. This is normally met since neural networks are usually only provided with as many parameters as can actually be set independently of one another. The more information a parameter Wᵢ contains with regard to the ultimately sought optimal parameters W**, the more relevantly this parameter Wᵢ can be evaluated.

Thus, in a further, particularly advantageous embodiment of the present invention, the functional dependence of the probability p(W|D) on individual parameters Wᵢ is generally measured on the basis of the Fisher information that the individual parameters Wᵢ contain in relation to a probability distribution of complete sets of parameters W for given training examples D. As explained above, the optimal set of parameters W** is the set of parameters that is most probable in light of the set D of training examples x.

The diagonal elements Fᵢᵢ of the Fisher information matrix F can be approximately calculated, for example, as the expected value of derivatives (squared elementwise) of the cost function L with respect to the individual parameters Wᵢ on the set D of training examples x:

$${F}_{i i} = \frac{1}{\vert D \vert} {\sum }_{x ∈ D} {( \frac{( δ log {p}_{W} ( y = {y}_{x}^{*} \vert x ) )}{δ {W}_{i}} )}^{2} .$$

Here, p_{W}(y=yₓ*|x) is the probability that the neural network parameterized with the parameter set W would map the training example x to exactly the output y* as in the case in which the neural network was parameterized with the optimal parameter set W**.

The diagonal elements Fᵢᵢ can thus already be ascertained approximately from first derivatives and indicate, for each individual parameter Wᵢ, a value that describes how strong an effect this individual parameter Wᵢ has on the (local) curvature of the cost function L.

Thus, in a further, particularly advantageous embodiment of the present invention, the Fisher information of at least one individual parameter Wᵢ is ascertained from functional dependencies of probabilities that the neural network delivers, for individual training examples x ED, the same output as in the optimally parameterized state W**, on the individual parameter Wt.

In a further, particularly advantageous embodiment of the present invention, after the optimization, the agreement of outputs of the neural network with respective target outputs is also checked for test examples and/or validation examples not seen during the optimization. In this way, it is possible to determine, for example, whether the neural network trained on the client node C1, . . . , CN really generalizes well to examples that were not seen, or whether it merely learned the respective training examples x from the set D “by heart” (overfitting). The optimized parameters can also be finely tuned, for example on the basis of the test examples and/or validation examples.

In a further, particularly advantageous embodiment, the predefined criterion for relevance of selected parameters W^{#} includes that a measure of the relevance of individual parameters Wᵢ is above a predefined threshold value. As explained above, it is to be expected that really authoritative proposed changes will be developed only for a few individual parameters Wᵢ, while only small proposed changes will result for many parameters Wᵢ. The contrast is high enough that a threshold value can be well-defined without appearing arbitrary.

In a further, particularly advantageous embodiment of the present invention, the proposed changes ΔW^{#} comprise gradients that specify a direction for changes of the selected parameters W^{#}. The training is then modeled on training with a central entity based solely on the stochastic gradient descent method. The gradients provided by a plurality of client nodes C1, . . . , CN for one and the same selected parameter W^{#} can be offset against each other.

The present invention also provides a method for the federated training of a neural network. This method combines the work performed by many client nodes C1, . . . , CN in the scope of the method described above to form an end result with regard to the set of parameters W.

In the scope of this method, a server node Q initializes a complete set of parameters W that characterize the behavior of the neural network. This can, for example, be done with random values but also with a work result from a previous optimization, for example.

The complete set of parameters W is distributed by the server node Q to a plurality of client nodes C1, . . . , CN. Therefrom, the client nodes C1, . . . , CN ascertain proposed changes ΔW^{#} for respectively selected parameters W^{#} using the above-described method and send them to the server node Q.

The server node Q aggregates the proposed changes ΔW^{#} to form a change ΔW of the set of parameters W. By applying this change ΔW, the set of parameters W is moved closer to the optimal parameters W**.

In order to bring the parameters W even closer to the optimum parameters W**, any number of further iterations of this type can be performed. In particular, the complete set of parameters W can thus, for example, be distributed again to the client nodes C1, . . . , CN after applying the change ΔW. Any termination criterion can be used to check whether the current optimized parameters W* are to be regarded as the best available approximation of the sought optimum W** or whether further iterations are useful. For example, the iterations can be ended when the parameters W change only insignificantly from one iteration to the next or when a predefined budget of iterations has been reached.

Aggregating the proposed changes ΔW^{#} can in particular include averaging, for example. Such an averaging also, for example, in particular meaningfully offsets with each other gradients that are proposed by different client nodes C1, . . . , CN for one and the same individual parameter Wᵢ and point in different directions.

In a further, particularly advantageous embodiment of the present invention, in order to aggregate the proposed changes ΔW^{#}, the proposed changes ΔW^{#} obtained from each client node C1, . . . , CN are each applied to a set W1, . . . , WN of parameters specific to this client node C1, . . . , CN. This step can be carried out by the server node Q but also already on the client node C1, . . . , CN. The client node C1, . . . , CN can therefore send its proposed change directly in the form of the modified relevant parameters W^{#} to the server node Q. For example, in the set W1, . . . , WN of parameters, the server node Q can set all parameters for which it has not received any proposed changes to 0.

Examples x_{d} from a predefined distillation data set Dd are now processed with instances of the neural network that are parameterized with the parameter sets W1, . . . , WN, to form outputs y_{d} in each case. The examples x_{d} thus become training examples for a supervised training of the parameters W. In the context of this training, the examples x_{d} are labeled with the target outputs y_{d}.

The parameters W are optimized in the scope of the supervised training with the aim that the neural network parameterized therewith maps the examples x_{d} as well as possible to the outputs y_{d} in accordance with a predefined cost function.

Compared to the direct averaging of proposed changes ΔW^{#}, this approach does not directly offset the proposed changes ΔW^{#} but rather their effects on the output of the neural network. These effects are not always correlated with the magnitude of the proposed changes ΔW^{#}. Depending on the specific shape of the “landscape” formed by the cost function L, a small change in a direction in which the cost function L is particularly sensitive can have a greater effect than a significantly larger change in a different direction. In such a case, the offsetting of the effects on the examples x_{d} from the distillation data set Dd assigns more meaningful weights to the contributions of the individual client nodes C1, . . . , CN.

The management of a set W1, . . . , WN of parameters specific to each client node C1, . . . , CN also offers further advantages if the training on the individual client nodes C1, . . . , CN runs at different speeds. This can usually be assumed because even if the client nodes C1, . . . , CN should work with nominally the same hardware, i.e., for example, always use the same instance size with the same cloud provider, different sets D of training examples x with different levels of difficulty already ensure that the local trainings on the client nodes C1, . . . , CN are not all completed at the same time. For example, the processing of training examples x representing traffic situations is easier in regions of the world where traffic is clearly structured with marked lanes, traffic lights and traffic signs than in regions of the world where there is no such clear structure and/or the infrastructure is dilapidated. For the processing of examples x_{d} from the distillation data set Dd to form outputs y_{d}, the currently up-to-date version of the respective set W1, . . . , WN of parameters for each client node C1, . . . , CN can always be used. When the client node C1, . . . , CN is finished with its next iteration of the training, its set W1, . . . , WN of parameters is updated.

Depending on the application and location, the client nodes C1, . . . , CN also may not always be able to communicate with the server node Q. If, for example, a network connection is only available intermittently or the transmittable data volume is limited (e.g., due to a quota of the mobile network provider or due to a restriction of the transmission time share for other radio applications), client nodes C1, . . . , CN may be dependent on continuing to train locally for longer until there is contact with the server node Q again.

Finally, aggregating the proposed changes via the processing of examples x_{d} from the distillation data set Dd to form outputs y_{d} also, for example, results in that the finally trained neural network automatically reserves more internal processing capacity for the training examples x from “more difficult” sets D than for the training examples x from “easier” sets D.

Once the neural network has been fully trained, it is supplied, in a further, particularly advantageous embodiment of the present invention, with measurement data xₘ that were recorded with at least one sensor. From the output yₘ then delivered by the neural network, a control signal z is formed. A vehicle, a robot, a driver assistance system, a quality control system, a system for monitoring areas, and/or a medical imaging system is controlled with the control signal z. In this context, the improved federated training has the effect that the response of the respectively controlled system to the control signal z is more likely to be appropriate to the situation embodied in the measurement data xₘ.

In a further, particularly advantageous embodiment of the present invention, an image classifier is selected as a neural network. An image classifier can map an input image onto classification scores in relation to one or more classes of a predefined classification but can also provide, for example, a semantic segmentation in which each pixel of the input image is assigned exactly one class. Image information in particular often contains personal data, such as faces, license plates, or other individualized identifiers. The merging of all image information in a central entity that carries out the training is therefore to be avoided in many cases for data protection reasons. In particular, the forwarding of personal image information from jurisdictions with more stringent data protection rules to jurisdictions with less stringent rules is often restricted. The merging of the data would also increase the attractiveness for an attacker because the attacker could capture all the data at once with only a single attack.

However, the neural network can also be used for many other tasks, such as the regression of a sought variable, the localization of objects, or the detection of anomalies in measurement data.

The methods according to the present invention can in particular be wholly or partially computer-implemented. The present invention therefore also relates to a computer program comprising machine-readable instructions that, when executed on one or more computers and/or compute instances, cause the computer(s) and/or compute instance(s) to perform one of the described methods. In this sense, control devices for vehicles and embedded systems for technical devices, which are also capable of executing machine-readable instructions, are to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for generating a training contribution for a neural network 1, according to the present invention.

FIG. 2 illustrates the savings in communication bandwidth between client nodes C1, . . . , CN and server nodes Q as a result of the method 100.

FIG. 3 shows an exemplary embodiment of the method 200 for the federated training of a neural network 1.

### DETAILED DESCRIPTION OF EXAMPLE EMBODIMENTS

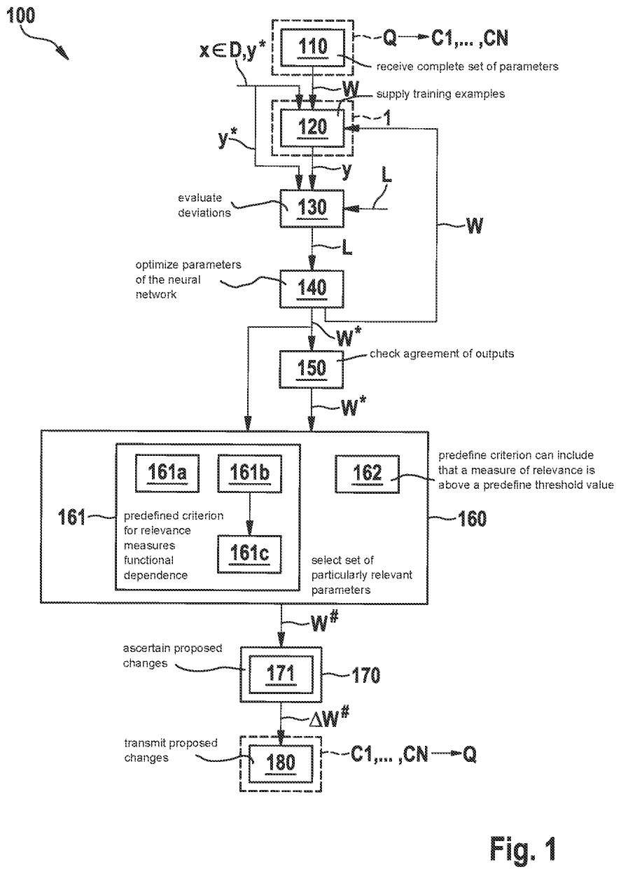

FIG. 1 is a schematic flow chart of the method 100 for generating a training contribution for a neural network 1. This method 100 is carried out on one or more client nodes C1, . . . , CN which work together with at least one server node Q.

In step 110, a complete set of parameters W that characterize the behavior of the neural network 1 is received from a server node Q.

In step 120, training examples x from a predefined set D are supplied to the neural network 1 parameterized with these parameters W. The neural network 1 then delivers outputs y in each case.

The training examples x are each labeled with target outputs y* which the neural network 1 should ideally deliver. In step 130, deviations of the outputs y from the respective target outputs y* are evaluated with a predefined cost function L.

In step 140, the parameters W of the neural network 1 are optimized with the aim of ensuring that, during further processing of training examples x, the evaluation by the cost function L is improved.

Optionally, in step 150 after the optimization 140, the agreement of outputs of the neural network 1 with respective target outputs may also be checked for test examples and/or validation examples that were not seen during the optimization.

In step 160, a set of particularly relevant parameters W^{#} is selected based on a predefined criterion.

In step 170, for the selected parameters W^{#}, proposed changes ΔW^{#} are ascertained as the sought training contribution on the basis of the result W* of the optimization.

In step 180, these proposed changes ΔW^{#} are transmitted to a server node Q.

According to block 161, the predefined criterion for the relevance of the parameters W can measure a functional dependence of the probability p(W|D) that, for given training examples D, the set of parameters W is correct overall, on individual parameters Wᵢ. It is then possible in particular, for example according to block 161a, to establish an approximation for the probability p(W|D), which comprises derivatives of the probability p(W|D) and/or of its logarithm log(p(W|D)) with respect to individual parameters Wᵢ.

According to block 161b, the functional dependence of the probability p(W|D) on individual parameters Wᵢ can be measured on the basis of the Fisher information that the individual parameters Wᵢ contain in relation to a probability distribution of complete sets of parameters W for given training examples D.

According to block 161c, the Fisher information of at least one individual parameter Wᵢ can be ascertained from functional dependencies of probabilities that the neural network (1) delivers, for individual training examples x ED, the same output as in the optimally parameterized state W**, on the individual parameter W.

According to block 162, the predefined criterion can include that a measure of the relevance of individual parameters Wᵢ is above a predefined threshold value.

According to block 171, the proposed changes ΔW^{#} can in particular, for example, comprise gradients that specify a direction for changes in the selected parameters W^{#}.

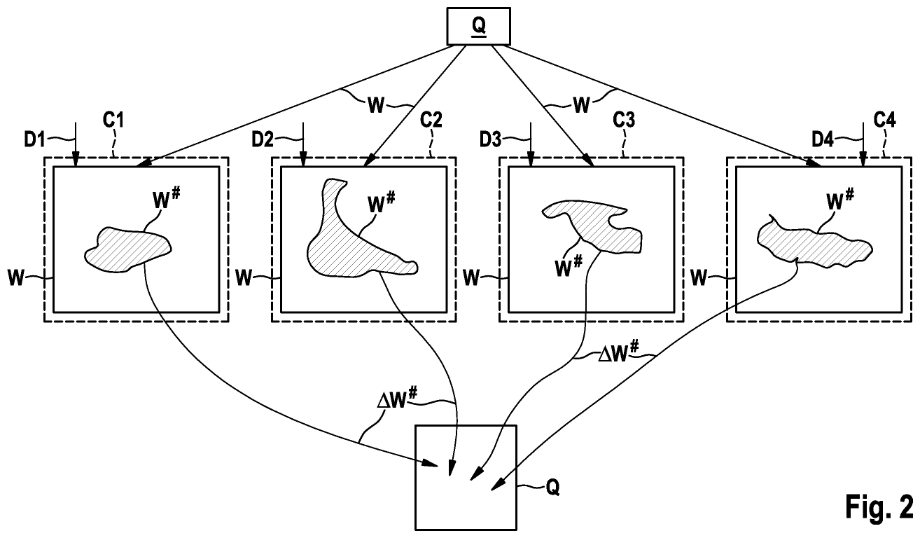

FIG. 2 illustrates the savings in communication bandwidth as a result of the use of the method 100 in an exemplary simple application with one server node Q and four client nodes C1, C2, C3 and C4.

The server node Q sends the full set of parameters W to all four client nodes C1, C2, C3 and C4. Each client node C1, C2, C3 and C4 has its own set D1, D2, D3 and D4 of training examples x for optimizing the parameters W. The training on these different sets D1, D2, D3 and D4 has the effect that different subsets W^{#} of the parameters W change in a particularly relevant way on the client nodes C1, C2, C3 and C4. Only for these relevant parameters W^{#} are proposed changes transmitted to the server node Q.

In the example shown in FIG. 2, the particularly relevant parameters W^{#} make up only less than a quarter of all parameters W in each case. Accordingly, in the transmission from the client nodes C1, C2, C3 and C4 to the server node Q, three-quarters of the data volume can be saved. During the initial transmission of the parameters W from the server node Q to the client nodes C1, C2, C3 and C4, a multicast method can, for example, be used so that the data only have to be sent once.

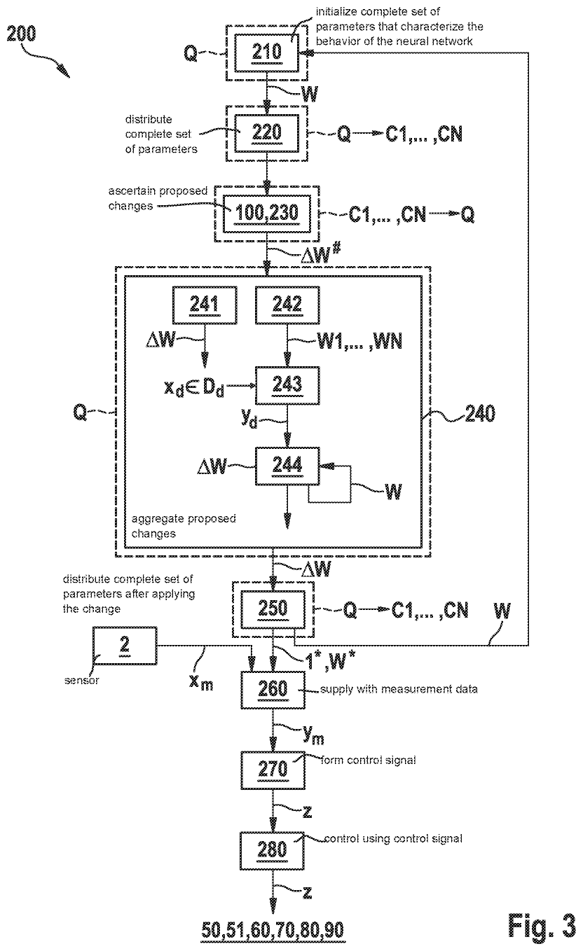

FIG. 3 is a schematic flow chart of an exemplary embodiment of the method 200 for the federated training of a neural network 1. This method 200 is performed on one or more server nodes Q but also utilizes the cooperation of a plurality of client nodes C1, . . . , CN.

In step 210, at least one server node Q initializes a complete set of parameters W that characterize the behavior of the neural network.

In step 220, the complete set of parameters W is distributed by the server node Q to a plurality of client nodes C1, . . . , CN.

In step 230, in the scope of the method 100, the client nodes C1, . . . , CN ascertain proposed changes ΔW^{#} for respectively selected parameters W^{#} and send them to the server node Q.

In step 240, the proposed changes ΔW^{#} are aggregated by the server node Q to form a change ΔW of the set of parameters W.

According to block 241, the aggregation 240 of the proposed changes ΔW^{#} can include an averaging.

Alternatively or in combination therewith, according to block 242, the proposed changes ΔW^{#} obtained from each client node C1, . . . , CN can in each case be applied to a set W1, . . . , WN of parameters specific to this client node C1, . . . , CN. As explained above, this step can already be performed on the client nodes C1, . . . , CN.

According to block 243, examples x_{d} from a predefined distillation data set Dd can then in each case be processed with instances of the neural network (1) that are parameterized with the parameter sets W1, . . . , WN, to form outputs Yd.

According to block 244, the parameters W can then be optimized with the aim that the neural network 1 parameterized with them maps the examples x_{d} as well as possible to the outputs y_{d} in accordance with a predefined cost function.

Thus, from separate instances of the neural network 1, each of which is parameterized on the basis of proposed changes from just one client node C1, . . . , CN, outputs y_{d} are obtained for the examples x_{d} from the distillation data set Dd. The pairs of examples x_{d} and outputs y_{d} are pooled and are used for supervised training of the neural network 1 that is ultimately to be trained, i.e., for the optimization of its parameters W.

In step 250, the complete set of parameters W is distributed again to the client nodes C1, . . . , CN after applying the change ΔW. That is to say, a further iteration of the training is carried out. This can be repeated until an arbitrary predefined termination condition is reached. The then present, finally trained state of the neural network 1 is denoted by reference sign 1*, and the optimized parameters W* that are then present are regarded as the final approximation of the true optimal parameters W**.

In step 260, the trained neural network 1* is supplied with measurement data xₘ that were recorded with at least one sensor 2.

In step 270, from the output yₘ then delivered by the neural network 1, a control signal z is formed.

In step 280, a vehicle 50, a robot 51, a driver assistance system 60, a quality control system 70, a system 80 for monitoring areas, and/or a medical imaging system 90 is controlled with the control signal z.

1-17. (canceled)

18. A method for generating a training contribution for a neural network on a client node for a federated training of the neural network, the method comprising the following steps:
receiving a complete set of parameters that characterize a behavior of the neural network from a server node;
supplying the neural network parameterized with the set of parameters with training examples from a predefined set so that the neural network in each case delivers outputs, wherein the training examples are each labeled with target outputs' evaluating deviations of the outputs from the respective target outputs with a predefined cost function;
optimizing the parameters of the neural network are optimized with a goal of ensuring that, during further processing of training examples, the evaluation by the cost function is improved;
selecting a set of particularly relevant parameters based on a predefined criterion;
for the selected parameters, ascertaining proposed changes as the training contribution based on a result of the optimization; and
transmitting the proposed changes to the server node.

19. The method according to claim 18, wherein the predefined criterion for the relevance of the parameters measures a functional dependence of a probability that, for given training examples, the set of parameters is correct overall, on individual parameters.

20. The method according to claim 19, wherein an approximation for the probability is established, which includes derivatives: (i) of the probability and/or (ii) of a logarithm of the probability, with respect to individual parameters.

21. The method according to claim 19, wherein the functional dependence of the probability on individual parameters is measured based on Fisher information that the individual parameters contain in relation to a probability distribution of complete sets of parameters for given training examples.

22. The method according to claim 21, wherein the Fisher information of at least one individual parameter is ascertained from functional dependencies of probabilities that the neural network delivers, for individual training examples, the same output as in an optimally parameterized state, on the individual parameter.

23. The method according to claim 18, wherein, after the optimization, an agreement of outputs of the neural network with respective target outputs is also checked for test examples and/or validation examples, that were not seen during the optimization.

24. The method according to claim 18, wherein the predefined criterion includes that a measure of a relevance of individual parameters is above a predefined threshold value.

25. The method according to claim 18, wherein the proposed changes include gradients that specify a direction for changes in the selected parameters.

26. A method for a federated training of a neural network, comprising the following steps:
initialing, by a server node, a complete set of parameters that characterize a behavior of the neural network;
distributing the complete set of parameters, by the server node, to a plurality of client nodes, the client nodes ascertaining proposed changes for respectively selected parameters and sending the proposed changes to the server node; and
aggregating the proposed changes by the server node to form a change of the set of parameters.

27. The method according to claim 26, wherein the complete set of parameters is again distributed to the client nodes after applying the change.

28. The method according to claim 26, wherein the aggregation of the proposed changes includes an averaging.

29. The method according to claim 27, wherein the aggregation of the proposed changes includes:
applying the proposed changes, obtained from each client node, in each case to a set of parameters specific to the client node;
processing examples from a predefined distillation data set with instances of the neural network that are parameterized with the sets of parameters, to form outputs in each case; and
optimizing the parameters with the aim that the neural network parameterized therewith maps the examples to the outputs as well as possible in accordance with a predefined cost function.

30. The method according to claim 26, wherein:
the trained neural network is supplied with measurement data that were recorded with at least one sensor;
from output delivered by the trained neural network, a control signal is formed; and
a vehicle, and/or a robot, and/or a driver assistance system, and/or a quality control system, and/or a system for monitoring areas, and/or a medical imaging system, is controlled with the control signal.

31. The method according to claim 18, wherein the neural network is an image classifier.

32. A non-transitory machine-readable data carrier on which is stored a computer program for generating a training contribution for a neural network on a client node for a federated training of the neural network, the computer program, when executed by one or more computers and/or compute instances, causing the one or more computers and/or compute instances to perform the following steps:
receiving a complete set of parameters that characterize a behavior of the neural network from a server node;
supplying the neural network parameterized with the set of parameters with training examples from a predefined set so that the neural network in each case delivers outputs, wherein the training examples are each labeled with target outputs'
evaluating deviations of the outputs from the respective target outputs with a predefined cost function;
optimizing the parameters of the neural network are optimized with a goal of ensuring that, during further processing of training examples, the evaluation by the cost function is improved;
selecting a set of particularly relevant parameters based on a predefined criterion;
for the selected parameters, ascertaining proposed changes as the training contribution based on a result of the optimization; and
transmitting the proposed changes to the server node.

33. One or more computers and/or compute instances equipped with a non-transitory machine-readable data carrier on which is stored a computer program for generating a training contribution for a neural network on a client node for a federated training of the neural network, the computer program, when executed by the one or more computers and/or compute instances, causing the one or more computers and/or compute instances to perform the following steps:
receiving a complete set of parameters that characterize a behavior of the neural network from a server node;
supplying the neural network parameterized with the set of parameters with training examples from a predefined set so that the neural network in each case delivers outputs, wherein the training examples are each labeled with target outputs'
evaluating deviations of the outputs from the respective target outputs with a predefined cost function;
optimizing the parameters of the neural network are optimized with a goal of ensuring that, during further processing of training examples, the evaluation by the cost function is improved;
selecting a set of particularly relevant parameters based on a predefined criterion;
for the selected parameters, ascertaining proposed changes as the training contribution based on a result of the optimization; and
transmitting the proposed changes to the server node.
